(19) United States
(12) Patent Application Publication
(10) Pub. No.: US 2025/0069211 A1
(43) Pub. Date: Feb. 27, 2025

(54) IMAGE ANALYSIS METHODS AND APPARATUSES, AND COMPUTER DEVICE AND STORAGE MEDIUM

(71) Applicant: BEIJING BYTEDANCE NETWORK TECHNOLOGY CO., LTD., Beijing (CN)

(72) Inventor: Likun Wang, Beijing (CN)

(21) Appl. No.: 18/726,084

(22) PCT Filed: Mar. 28, 2023
(86) PCT No.: PCT/CN2023/084326

§ 371 Date: Jul. 1, 2024

(30) Foreign Application Priority Data
Apr. 6, 2022 (CN) 202210357014.3

(51) Int. Cl. G06T 7/00

(52) U.S. Cl. CPC G06T 7/0002

(57) ABSTRACT

The present disclosure provides image analysis methods and apparatuses, and a computer device and a storage medium. The method comprises: in response to an image analysis instruction for a target page in a target application, obtaining control attribute information of various view controls of the target page; determining a target view control from the various view controls based on the control attribute information, the target view control being an image control containing an image; generating an image obtaining request based on the target view control, and sending it to a terminal device, wherein the image obtaining request is used for instructing the terminal device to obtain a control image and image information of the target view control; and obtaining the control image and the image information from the terminal device, and performing, based on the image information, image analysis on the control image to obtain an image analysis result.

The present disclosure claims priority to Chinese Patent Application No. 202210357014.3, filed with the China National Intellectual Property Administration on Apr. 6, 2022, and entitled “IMAGE ANALYSIS METHODS AND APPARATUSES, AND COMPUTER DEVICE AND STORAGE MEDIUM”, the disclosure of which is incorporated herein by reference in its entirety.

### FIELD

The present disclosure relates to the technical field of computers, and in particular, to an image analysis method and apparatus, and a computer device and a storage medium.

### BACKGROUND

As display interfaces of applications have more and more diverse forms, embedding images in interface components of applications is increasingly popular. However, image loading has great impact on the display performance of a terminal device, such as traffic consumption caused by image obtaining over a network and consumption of memory a memory and a Central Processing Unit (CPU) by images.

However, in an existing development process of an application, it is often impossible to analyze images in the application, so that unreasonable image scenes cannot be determined, and developers cannot be guided to adjust unreasonable image scenes. As a result, a high memory load may be caused during use of the application.

### SUMMARY

The embodiments of the present disclosure provide at least an image analysis method and apparatus, and a computer device and a storage medium.

In a first aspect, the embodiments of the present disclosure provide an image analysis method, applied to a Flutter performance debugger, comprising:
in response to an image analysis instruction for a target page in a target application, obtaining control attribute information of various view controls of the target page;
determining a target view control from the various view controls based on the control attribute information, wherein the target view control is an image control containing an image;
generating an image obtaining request based on the target view control, and sending the image obtaining request to a terminal device, wherein the image obtaining request is used for instructing the terminal device to obtain a control image and image information of the target view control; and
obtaining the control image and the image information contained in the target view control which are returned by the terminal device based on the image obtaining request, and performing, based on the image information, image analysis on the control image to obtain an image analysis result.

In an optional implementation, determining the target view control from the various view controls based on the control attribute information comprises:
obtaining a control structure tree of the plurality of view controls, and determining a main view control corresponding to a root node of the control structure tree, wherein the control structure tree comprises a plurality of nodes and hierarchical relationships between individual ones of the plurality of nodes, and each node corresponds to a view control in the target page; and
traversing the control structure tree based on the main view control to obtain the target view control.

In an optional implementation, traversing the control structure tree based on the main view control to obtain the target view control comprises:
traversing the control attribute information of the various view controls in the control structure tree according to a traversing order by using the main view control as a start view control to obtain an attribute traversing result, wherein the traversing order is determined based on the start view control and the control structure tree; and
determining a view control comprising an image attribute in the attribute traversing result as the target view control.

In an optional implementation, the method further comprises:
after performing, based on the image information, image analysis on the control image to obtain an image analysis result, creating a present list based on the image analysis result, wherein the present list comprises a plurality of present regions, and each present region correspondingly presents relevant information of a target view control; and
presenting the relevant information of the target view control in the corresponding present region of the present list, wherein the relevant information comprises at least one of the following: the control image, the image information, or the image analysis result.

In an optional implementation, the relevant information comprises the image analysis result, and presenting the relevant information of the target view control in the corresponding present region of the present list comprises:
in a case that it is determined, based on the image analysis result, that the control image comprises an abnormal control image, determining abnormal label information of the abnormal control image; and
presenting the abnormal control image in the corresponding present region of the present list according to the abnormal label information.

In an optional implementation, performing, based on the image information, image analysis on the control image to obtain an image analysis result comprises:
obtaining a current image size of the control image and an original image size of the control image from the image information;
comparing the current image size with the original image size to obtain a comparison result; and
in a case that it is determined, based on the comparison result, that the original image size is greater than the current image size, determining the control image as an abnormal control image.

In an optional implementation, the image information comprises at least one of the following: a current image size of the control image, a memory usage of the control image in the terminal device, an original image size of the control image, or an image source of the control image.

In an optional implementation, obtaining the control image and the image information contained in the target view control which are returned by the terminal device based on the image obtaining request comprises:
obtaining control image data returned by the terminal device based on the image obtaining request; and
performing format transformation on the control image data according to a preset data format to obtain the control image and the image information of the target view control, wherein the preset data format is a data format matched with the Flutter performance debugger.

In a second aspect, the embodiments of the present disclosure further provide an image analysis method, applied to a terminal device running a target application, the method comprising:
receiving an image obtaining request sent by a Flutter performance debugger, and determining a target view control corresponding to the image obtaining request; and
obtaining a control image and image information of the target view control, and returning the control image and the image information to the Flutter performance debugger.

In an optional implementation, determining the target view control corresponding to the image obtaining request comprises:
determining view control information contained in the image obtaining request; and
determining a view control corresponding to the view control information as the target view control.

In an optional implementation, obtaining a control image and image information of the target view control comprises:
obtaining control attribute information of the target view control;
performing a loading operation for the control image of the target view control in the control attribute information based on a loading parameter to obtain a loading result, and determining a current image size of the control image based on the loading result, wherein the loading result is used for indicating a rendering result of the control image, and the loading parameter comprises at least one of the following: an original image size of the control image, a memory usage of the control image in the terminal device, or an image source of the control image; and
determining the control image and the image information of the target view control according to the loading result and the loading parameter.

In an optional implementation, after obtaining the control image and the image information of the target view control, the method further comprises:
determining a preset data format matched with the Flutter performance debugger;
performing data format transformation on the control image and image information of the target view control according to the preset data format to obtain control image data of the target view control; and
transmitting, through a debug extension application of the Flutter application, the control image data of the target view control into the Flutter performance debugger for processing.

In a third aspect, the embodiments of the present disclosure provide an image analysis apparatus, configured in a Flutter performance debugger, comprising:
a first obtaining unit, configured to: in response to an image analysis instruction for a target page in a target application, obtain control attribute information of various view controls of the target page;
a determining unit, configured to determine a target view control from the various view controls based on the control attribute information, wherein the target view control is an image control containing an image;
a generation unit, configured to: generate an image obtaining request based on the target view control, and send the image obtaining request to a terminal device, wherein the image obtaining request is used for instructing the terminal device to obtain a control image and image information of the target view control; and
a second obtaining unit, configured to: obtain the control image and the image information contained in the target view control which are returned by the terminal device based on the image obtaining request, and perform, based on the image information, image analysis on the control image to obtain an image analysis result.

In a fourth aspect, the embodiments of the present disclosure further provide an image analysis apparatus, configured in a terminal device having a target application run thereon, comprising:
a receiving unit, configured to: receive an image obtaining request sent by a Flutter performance debugger, and determine a target view control corresponding to the image obtaining request; and
a third obtaining unit, configured to: obtain a control image and image information of the target view control, and return the control image and the image information to the Flutter performance debugger.

In a fifth aspect, the embodiments of the present disclosure further provide a computer device, comprising a processor, a memory, and a bus, wherein the memory stores machine-readable instructions executable by the processor; when the computer device is run, the processor communicates with the memory through the bus; and the machine-readable instructions, when executed by the processor, execute steps in any possible implementation in the first aspect to the second aspect.

In a sixth aspect, the embodiments of the present disclosure further provide a computer-readable storage medium, wherein the computer-readable storage medium stores a computer program, and the computer program, when run by a processor, executes steps in any possible implementation in the first aspect to the second aspect.

According to the image analysis methods and apparatuses, and the computer device and the storage medium provided by the embodiments of the present disclosure, a target view control, containing an image, in a target application can be determined; and image information of the control image in the target view control is obtained and is analyzed to obtain an analysis result of the control image, such that a developer can determine an unreasonable control image according to the analysis result and adjust the control image, thereby reducing the impact of image loading on the display performance of the terminal device and reducing a memory load on the target application during use.

In order to make the above objectives, features, and advantages of the present disclosure more apparent and understandable, the following text provides preferred embodiments. A detailed explanation is made below in conjunction with the accompanying drawings.

### BRIEF DESCRIPTION OF THE DRAWINGS

In order to explain the technical solutions of the embodiments of the present disclosure more clearly, the drawings required to be used in the embodiments are briefly introduced below. The drawings here are incorporated into and form part of this specification. These drawings show the embodiments that comply with the present disclosure, and are used together with this specification to explain the technical solutions of the present disclosure. It should be understood that the accompanying drawings below only show some embodiments of the present disclosure. Therefore, the embodiments shall not be regarded as limitations on the scope. A person of ordinary skill in the art can also derive other relevant drawings according to these drawings without creative work.

FIG. 1 shows a flowchart of an image analysis method provided by embodiments of the present disclosure;

FIG. 2 shows a schematic diagram of some nodes in a control structure tree provided by embodiments of the present disclosure;

FIG. 3 shows a schematic diagram of a present list provided by embodiments of the present disclosure;

FIG. 4 shows a flowchart of another image analysis method provided by embodiments of the present disclosure;

FIG. 5 shows a schematic diagram of an image analysis apparatus provided by embodiments of the present disclosure;

FIG. 6 shows a schematic diagram of another image analysis apparatus provided by embodiments of the present disclosure;

FIG. 7 is a schematic diagram of a computer device provided by embodiments of the present disclosure; and

FIG. 8 is a schematic diagram of another computer device provided by embodiments of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. Assemblies of the embodiments of the present disclosure commonly described and shown in the accompanying drawings here may be arranged and designed in a variety of different configurations. Therefore, the following detailed descriptions of the embodiments of the present disclosure provided in the accompanying drawings are not intended to limit the scope of the claimed present disclosure, but merely represents selected embodiments of the present disclosure. All other embodiments obtained by a person skilled in the art based on the embodiments of the present disclosure without making creative efforts shall fall within the protection scope of the present disclosure.

It should be noted that similar reference numerals and letters indicate similar items in the following drawings. Therefore, once a certain item is defined in one drawing, it is unnecessary to further define and explain it in the subsequent drawings.

The term “and/or” herein only describes an association relationship, representing that three relationships may exist. For example, A and/or B may represent three situations: A exists alone; A and B exist simultaneously; and B exists alone. In addition, the term “at least one” herein refers to any one or any combination of at least two of a variety, for example, comprising at least one of A, B, or C, which can represent any one or more elements selected from a set composed of A, B, and C.

Studies found that in an existing development process of an application, it is often impossible to analyze images in the application, so that unreasonable image scenes cannot be determined, and developers cannot be guided to adjust unreasonable image scenes. As a result, a high memory load may be caused during use of the application.

Based on the above studies, the present disclosure provides an image analysis method and apparatus, and a computer device and a storage medium. In the embodiments of the present disclosure, a target view control, containing an image, in a target application can be determined; and image information of the control image in the target view control is obtained and is analyzed to obtain an analysis result of the control image. As such, a developer can determine an unreasonable control image according to the analysis result and adjust the control image, thereby reducing the impact of image loading on the display performance of the terminal device and reducing a memory load on the target application during use.

For ease of understanding this embodiment, an image analysis method disclosed by embodiments of the present disclosure is introduced in detail first. An executive body of the image analysis method provided by embodiments of the present disclosure is generally a computer device with a computing ability. In some possible implementations, the image analysis method may be achieved by a processor by calling computer-readable instructions stored in a memory.

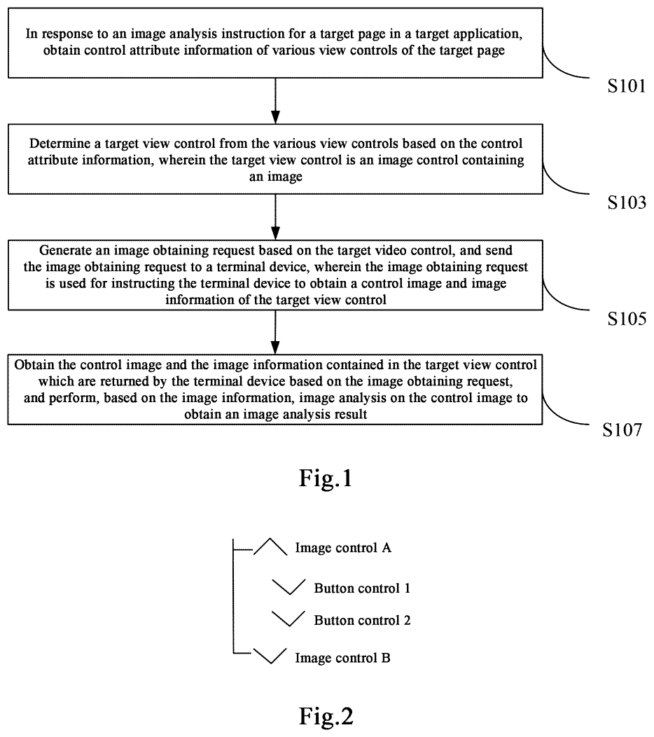

FIG. 1 shows a flowchart of an image analysis method provided by embodiments of the present disclosure, applied to a Flutter performance debugger. The method comprises step S101 to step S107.

S101: In response to an image analysis instruction for a target page in a target application, control attribute information of various view controls of the target page is obtained.

In the embodiments of the present disclosure, a communication connection between the Flutter performance debugger and the target application is first established. Then, after the image analysis instruction for the target page in the target application is detected, the Flutter performance debugger may send an obtaining request to the target application. The obtaining request comprises a page identifier of the target page in the target application.

Next, the target application may determine the target page corresponding to the obtaining request based on the page identifier carried by the obtaining request. After the target page is determined, the view controls in the target page may be determined. The view controls are basic elements that make up the target page, such as buttons, password boxes, list boxes, and avatar boxes. Then, the control attribute information of the various view controls on the target page may be returned to the Flutter performance debugger.

The above control attribute information may be used for indicating control types of the corresponding view controls.

S103: A target view control is determined from the various view controls based on the control attribute information, wherein the target view control is an image control containing an image.

In the embodiments of the present disclosure, since functions achieved by the above various view controls on the target page are not the same, content contained in each view control may also be different.

First, the control attribute information of each view control may be obtained separately, and filling information contained in the control attribute information may be determined, so that the various view controls are filtered based on the filling information to obtain the image control containing an image, and the image control is determined as the target view control. The filling information is used for representing the content contained in the corresponding view control. It should be noted that when the above view control is the image control containing an image, the filling information of the view control may be Image.

S105: An image obtaining request is generated based on the target view control, and the image obtaining request is sent to a terminal device, wherein the image obtaining request is used for instructing the terminal device to obtain a control image and image information of the target view control.

In the embodiments of the present disclosure, after the above target view control is determined, a control identifier of the target view control may be obtained, such as a control id. Then, the image obtaining request is generated for the target view control based on the control identifier. The image obtaining request is used for instructing the terminal device to load the control image contained in the target view control, thereby obtaining an image resource of the control image (wherein the control image may also be referred to as ui.image) of the target view control. Based on the image resource, the control image and the image information corresponding to the control image of the target view control are determined.

S107: The control image and the image information contained in the target view control which are returned by the terminal device based on the image obtaining request are obtained, and image analysis is performed, based on the image information, on the control image to obtain an image analysis result.

In the embodiments of the present disclosure, after the control image and the image information which are returned by the terminal device are obtained, the control image can be analyzed based on the image information to obtain the image analysis result. Specifically, in the process of analyzing the information of the control image, it can be analyzed whether there is a loading anomaly for the control image.

For example, the above image information comprises memory usage information of the control image. Based on an image analysis operation, it can be determined whether the memory usage of the control image is reasonable. If the memory usage is too high, namely, if the memory usage of the control image does not meet a memory requirement, an image analysis result representing that the memory usage of the control image is unreasonable can be determined.

As described above, in the embodiments of the present disclosure, a target view control, containing an image, in a target application can be determined; and image information of the control image in the target view control is obtained and is analyzed to obtain an analysis result of the control image, so that a developer can determine an unreasonable control image according to the analysis result and adjust the control image, so as to reduce the impact of image loading on the display performance of the terminal device and reduce a memory load on the target application during use.

In an optional implementation, in the above step S103, determining the target view control from the various view controls based on the control attribute information specifically comprises the following processes.

S1031: A control structure tree of the plurality of view controls is obtained, and a main view control corresponding to a root node of the control structure tree is determined, wherein the control structure tree comprises a plurality of nodes and hierarchical relationships between individual ones of the plurality of nodes, and each node corresponds to a view control in the target page.

S1032: The control structure tree is traversed based on the main view control to obtain the target view control.

In the embodiments of the present disclosure, the control structure tree of the target page may be used for indicating control structure information of the various view controls of the target page, namely, the hierarchical relationships between the various view controls.

The control structure tree comprises a plurality of nodes, and each node corresponds to a view control in the target page. The control structure tree is used for indicating the hierarchical relationships between the various view controls. The above hierarchical relationships between the various view controls may comprise stacking relationships between the various view controls and an arrangement order of the various view controls.

FIG. 2 shows a schematic diagram of some nodes in the above control structure tree. As can be seen from FIG. 2, the above stacking relationships may be used for indicating inclusion relationships between a plurality of nodes. For example, image control A comprises button control 1 and button control 2. The above arrangement order may be used for indicating arrangement positions of the plurality of view controls on the target page. For example, if image control A is located above image control B in the target page, the arrangement order of image control A may be located in front of image control B in the control structure tree.

Therefore, after the control structure tree of the plurality of view controls is obtained, the root node of the control structure tree needs to be determined, so as to start the traversing of the control attribute information of the view controls in the control structure tree from the main view control corresponding to the root node, thereby obtaining the target view control. The main view control corresponding to the root node of the control structure tree may be understood as a view control that has no relationship indicating being included. For example, as shown in FIG. 2, the main view control may be a page frame control of the target page.

In the embodiments of the present disclosure, after the control structure tree of the plurality of view controls of the target page is obtained, the control structure tree can be traversed based on the main view control corresponding to the root node in the control structure tree to obtain the target view control. As such, the efficiency of determining the target view control can be improved.

In an optional implementation, in step S1032, the control structure tree is traversed based on the main view control to obtain the target view control, which specifically comprises the following processes:
(1) the control attribute information of the various view controls in the control structure tree is traversed by using the main view control as a start view control, and an attribute traversing result is obtained; and
(2) a view control, comprising an image attribute, in the attribute traversing result is

determined as the target view control.

In the embodiments of the present disclosure, the determined main view control can be used as the start view control, and then a traversing order can be determined based on a node arrangement structure in the control structure tree. According to the traversing order starting with the main view control corresponding to a main node of the control structure tree, the view controls corresponding to various branch nodes are traversed one by one.

Specifically, the nodes in the control structure tree shown in FIG. 2 are taken as an example. A traversing order indicated by these nodes may be image control A, button control 1, button control 2, and image control B.

In the process of traversing the control attribute information of the various view controls in the control structure tree according to the above determined traversing order, the filling information in the control attribute information of the various view controls may be read, and it can be determined whether the filling information being read is the above Image, thereby obtaining the above attribute traversing result. In a case where it is determined that the filling information being read is Image, it can be determined that a view control using

Image as the filling information comprises an image attribute, and the view control is determined as the target view control.

In the embodiments of the present disclosure, by using the main view control as the start view control, the control attribute information of the various view controls in the control structure tree is traversed, and the target view control is determined according to the attribute traversing result, thereby further improving the efficiency of determining the target view control.

In an optional implementation, in step S107, the control image and the image information contained in the target view control which are returned by the terminal device based on the image obtaining request are obtained, which comprises:
(1) control image data returned by the terminal device based on the image obtaining request is obtained; and
(2) format transformation is performed on the control image data according to a preset data format to obtain the control image and the image information of the target view control, wherein the preset data format is a data format matched with the Flutter performance debugger.

In the embodiments of the present disclosure, the target application comprises a debug extension application. The communication connection between the target application and the Flutter performance debugger can be established based on the debug extension application, such that the control image data returned by the terminal device to which the target application belongs can be obtained based on the communication connection. The debug extension application can transfer data between the Flutter performance debugger and the Flutter application based on the WebSocket communication connection. In addition, the debug extension application may be extension.

Since the above debug extension application has a requirement for the format of transmitted data, wherein data that can be transmitted by the debug extension application has a data format of VMService, the above terminal device first transforms the determined control image and image information into the control image data in the format of VMService, such that the control image data can be sent to the Flutter performance debugger through the debug extension application.

After receiving the control image data, the Flutter performance debugger can transform the control image data in the format of VMService into a preset data format, so as to obtain the control image and the image information contained in the control image data.

In the embodiments of the present disclosure, in the above process of data transmission between the target application and the Flutter performance debugger, the control image data containing the control image and the image information can be first determined, and then the data transmission is performed, thereby improving the confidentiality of data transmission between the target application and the Flutter performance debugger to a certain extent.

In an optional implementation, the image information comprises at least one of the following: a current image size of the control image, a memory usage of the control image in the terminal device, an original image size of the control image, or an image source of the control image.

Specifically, the current image size of the above control image may be used for describing an image size of the control image in the target view control. The memory usage of the control image in the terminal device can be used for representing a usage of the memory of the terminal device after the loading of the control image in the terminal device is completed.

It should be understood that during the loading of the above control image, the image resource of the control needs to be obtained from the image source of the control image, and the control image is loaded according to the image resource. The image source of the above control image comprises: a network image and a locally cached image. The network image is an image that needs to be downloaded from a network during the loading of the control image, and the locally cached image is an image that is directly loaded from a cache of the terminal device during the loading. The original image size of the above control image is a size of the image resource of the control image at the image source. For example, when the image source of the control image is the locally cached image, the original image size of the control image is a size of the image resource of the control image in a local cache.

Through the above description, the image information comprises at least one of the following: the current image size of the control image, the capacity of the internal memory used by the control image in the terminal device, the original image size of the control image, or the image source of the control image. Therefore, obtaining the image information of the control image of the target view control provides a technical support for image analysis performed on the control image.

In an optional implementation, in the above step S107, image analysis is performed, based on the image information, on the control image to obtain an image analysis result, which specifically comprises the following processes:
(1) a current image size of the control image and an original image size of the control image is obtained from the image information;
(2) the current image size is compared with the original image size to obtain a comparison result; and
(3) in a case that it is determined, based on the comparison result, that the original image size is greater than the current image size, the control image is determined as an abnormal control image.

In the embodiments of the present disclosure, after the image information of the control image is obtained, the current image size of the control image and the original image size of the control image can be obtained from the image information. Next, the current image size can be compared with the original image size to obtain the comparison result.

It should be understood that under normal circumstances, it is difficult to control the image source of the above control image, so that it is possible that the original image size of the control image is too large and the memory usage is too high. Based on this, in the above process of constructing the target view control, the current image size of the control image in the target view control should be less than the original image size of the control image, so as to ensure that the control image does not use too much memory during the loading.

Therefore, a control image with the original image size greater than the current image size in the above comparison result needs to be determined, and the determined control image is determined as an abnormal control image for further anomaly confirmation based on the abnormal control image. In a case that the abnormal control image needs to be adjusted, the developer is guided to adjust the abnormal control image.

In specific implementation, the memory usage, in the image information, of the abnormal control image in the terminal device may be obtained, and whether the memory usage of the abnormal control image in the terminal device meets a usage requirement may be analyzed. The usage requirement may be a memory usage threshold. In a case that the memory usage of the abnormal control image in the terminal device is greater than the memory usage threshold, it is determined that the abnormal control image needs to be adjusted.

In the embodiments of the present disclosure, after the current image size of the control image and the original image size of the control image are obtained, the current image size can be compared with the original image size, and the control image with the original image size greater than the current image size can be determined as the abnormal control image, thereby ensuring that the control image in the target view control does not use too much memory to avoid the impact on the loading speed of the control image during the loading by the terminal device.

In an optional implementation, the above method further comprises the following processes:
(1) after image analysis is the performed, based on the image information, on the control image to obtain an image analysis result, a present list is created based on the image analysis result, wherein the present list comprises a plurality of present regions, and each present region correspondingly presents relevant information of a target view control; and
(2) the relevant information of the target view control is presented in the corresponding present region of the present list, wherein the relevant information comprises at least one of the following: the control image, the image information, or the image analysis result.

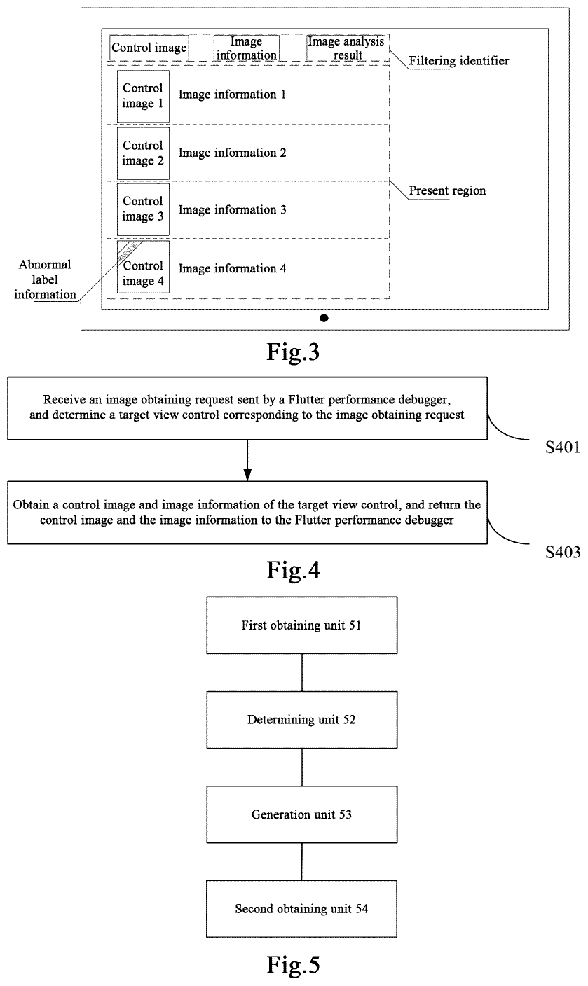

In the embodiments of the present disclosure, after the above image analysis result is determined, the present list can be further created through a state management control in the Flutter performance debugger. The present list is as shown in FIG. 3. The present list comprises a plurality of present regions, and each present region correspondingly presents relevant information of a target view control.

A user can further filter the relevant information presented in the present regions by using a filtering identifier. For example, in a default present case, the relevant information presented in the present region may be the control image, the image information, and the image analysis result. In addition, respective filtering buttons may be set for the control image, the image information, and the image analysis result. A user can trigger a filtering button to present only the relevant information corresponding to the filtering button in the above present region.

For example, after a triggering operation performed by a user on the filtering buttons corresponding to the control image and the image information is detected, the control image and image information of each target view control may be presented in the above present region.

In an optional implementation, in a case that the relevant information comprises the image analysis result, the relevant information of the target view control is presented in the corresponding present region of the present list, which specifically comprises the following processes:
(1) in a case that it is determined, based on the image analysis result, that the control image comprises an abnormal control image, abnormal label information of the abnormal control image is determined; and
(2) the abnormal control image is presented in the corresponding present region of the present list according to the abnormal label information.

In the embodiments of the present disclosure, in a case that it is determined that the control image comprises the abnormal control image, the abnormal control image can be labeled with the abnormal label information. For example, as shown in FIG. 3, the determined abnormal control image is control image 4 in FIG. 3. Control image 4 may be labeled with the abnormal label information (the abnormal label information is a “WARNING” identifier in FIG. 3), so that the developer can adjust the abnormal control image, thereby reducing the impact caused by image loading on the display performance of the terminal device.

FIG. 4 shows a flowchart of another image analysis method provided by embodiments of the present disclosure, applied to a terminal device running a target application. The method comprises steps S401 to S403.

S401: An image obtaining request sent by a Flutter performance debugger is received, and a target view control corresponding to the image obtaining request is determined.

In the embodiments of the present disclosure, after the image obtaining request sent by the Flutter performance debugger is obtained, a control identifier carried in the image obtaining request can be obtained, and the target view control corresponding to the control identifier can be determined. The control identifier may be a control id.

S403: A control image and image information of the target view control are obtained, and the control image and the image information are returned to the Flutter performance debugger.

In the embodiments of the present disclosure, after the target view control contained in the above target page is determined, the control image and the image information which correspond to each target view control can be obtained.

Since the communication connection between the target application and the Flutter performance debugger is established based on the debug extension application, and the debug extension application requires the transmitted data to have the data format of VMService, the obtained control image and image information need to be transformed into the control image data in the format of VMService, such that the control image data can be returned to the Flutter performance debugger.

It can be known from the above description that in the embodiments of the present disclosure, in response to an image obtaining request sent by the Flutter performance debugger, a target view control contained in a target application can be determined, and a control image and image information of the target view control can be obtained and then returned to the Flutter performance debugger. As such, the Flutter performance debugger can analyze the control image based on the image information, thereby obtaining an analysis result of the control image. The developer can determine an unreasonable control image according to the analysis result and adjust the control image, thereby reducing the impact caused by image loading on the display performance of the terminal device and reducing a memory load on the target application in a use process.

In an optional implementation, in step S401, the target view control corresponding to the image obtaining request is determined, which specifically comprises the following processes:

S4011: view control information contained in the image obtaining request is determined; and

S4012: a view control corresponding to the view control information is determined as the target view control.

In the embodiments of the present disclosure, the above view control information can comprise the above control identifier. After the view control information contained in the image obtaining request is obtained, view controls contained in the target page of the target application can be traversed to determine a view control that is matched with the view control information, and the determined view control is determined as the target view control.

In the embodiments of the present disclosure, the image obtaining request may contain view control information, so that the target application can determine the corresponding target view control according to the view control information, thereby improving the accuracy of determining the target view control.

In an optional implementation, in step S403, the control image and the image information of the target view control are obtained, which specifically comprises the following processes:
S4031: control attribute information of the target view control is obtained;
S4032: a loading operation is performed for the control image of the target view control in the control attribute information based on a loading parameter to obtain a loading result, and a current image size of the control image is determined based on the loading result, wherein the loading result is used for indicating a rendering result of the control image, and the loading parameter comprises at least one of the following: an original image size of the control image, a memory usage of the control image in the terminal device, or an image source of the control image; and
S4033: the control image and image information of the target view control are determined according to the loading result and the loading parameter.

In the embodiments of the present disclosure, the above control attribute information may comprise the control image of the target view control, and the loading parameter corresponding to the control image. The loading operation can be performed for the control image based on the loading parameter of the control image, so as to obtain the loading result.

In specific implementation, the control image to be loaded by the loading operation and a corresponding loading address can be first determined based on the image source of the control image in the loading parameter. Then the content of the control image to be loaded by the loading operation can be determined based on the original image size of the control image and the memory usage of the control image in the loading parameter. At this time, the loading operation can be performed for the control image based on the determined loading address and the determined content of the control image.

In the embodiments of the present disclosure, the control attribute information of the target view control needs to be first obtained, and the loading operation is then performed for the control image in the control attribute information based on the loading parameter to obtain the loading result, so that the control image and image information of the target view control can be determined based on the loading result and the control attribute information, enriching the content of the obtained image information.

In an optional implementation, after a control image and image information of the target view control are obtained, the above method further comprises the following processes:
(1) a preset data format matched with the Flutter performance debugger is determined;
(2) data format transformation is performed on the control image and image information of the target view control according to the preset data format to obtain control image data of the target view control; and
(3) the control image data of the target view control is transmitted, through a debug extension application of the target application, into the Flutter performance debugger for processing.

In the embodiments of the present disclosure, the preset data format matched with the Flutter performance debugger can be a transmitted data format corresponding to the debug extension application in the target application, such as the format of VMService as mentioned above. In specific implementation, after the control image and image information of the above target view control are determined, the data format transformation can be performed on the control image and the image information to obtain the control image data in the format of VMService, such that the control image data can be sent to the Flutter performance debugger through the debug extension application.

In the embodiments of the present disclosure, in the above process of data transmission between the target application and the Flutter performance debugger, the data format transformation is first performed on the control image and the image information to obtain the control image data of the target view control, thereby improving the confidentiality of data transmission between the target application and the Flutter performance debugger to a certain extent.

In summary, in the embodiments of the present disclosure, a target view control, containing an image, in a target application can be determined; and image information of the control image in the target view control is obtained and is analyzed to obtain an analysis result of the control image. As such, a developer can determine an unreasonable control image according to the analysis result and adjust the control image, thereby reducing the impact of image loading on the display performance of the terminal device and reducing a memory load on the target application during use.

A person skilled in the art can understand that in the methods mentioned above of the specific implementations, the writing order of the respective step does not imply a strict execution order and imposes any restrictions on the implementation process. The specific execution order of the respective steps should be determined on the basis of functions and possible internal logics of the steps.

Based on the same inventive concept, the embodiments of the present disclosure further provide image analysis apparatuses corresponding to the image analysis methods.

Since the principle of the apparatuses in the embodiments of the present disclosure for solving the problem is similar to the image analysis methods described above in the embodiments of the present disclosure, the implementation of the apparatuses can be found in the implementation of the methods, and any repetition will be omitted.

FIG. 5 shows a schematic diagram of an image analysis apparatus provided by embodiments of the present disclosure, which is configured in a Flutter performance debugger. The apparatus comprises: a first obtaining unit 51, a determining unit 52, a generation unit 53, and a second obtaining unit 54.

The first obtaining unit 51 is configured to: in response to an image analysis instruction for a target page in a target application, obtain control attribute information of various view controls of the target page;

the determining unit 52 is configured to determine a target view control from the various view controls based on the control attribute information, wherein the target view control is an image control containing an image;

the generation unit 53 is configured to: generate an image obtaining request based on

the target view control, and send the image obtaining request to a terminal device, wherein the image obtaining request is used for instructing the terminal device to obtain a control image and image information of the target view control; and

the second obtaining unit 54 is configured to: obtain the control image and the image information contained in the target view control which are returned by the terminal device based on the image obtaining request, and perform, based on the image information, image analysis on the control image to obtain an image analysis result.

In the embodiments of the present disclosure, a target view control, containing an image, in a target application can be determined; and image information of the control image in the target view control is obtained and is analyzed to obtain an analysis result of the control image. As such, a developer can determine an unreasonable control image according to the analysis result and adjust the control image, so as to reduce the impact of image loading on the display performance of the terminal device and reduce a memory load on the target application during use.

In a possible implementation, the determining unit 52 is further configured to:
obtain a control structure tree of the plurality of view controls, and determine a main view control corresponding to a root node of the control structure tree, wherein the control structure tree comprises a plurality of nodes and hierarchical relationships between individual ones of the plurality of nodes, and each node corresponds to a view control in the target page; and
traverse the control structure tree based on the main view control to obtain the target view control.

In a possible implementation, the determining unit 52 is further configured to:
traverse the control attribute information of the various view controls in the control structure tree by using the main view control as a start view control, and obtain an attribute traversing result; and
determine a view control comprising an image attribute in the attribute traversing result as the target view control.

In one possible implementation, the above apparatus is further configured to:
after performing, based on the image information, image analysis on the control image to obtain the image analysis result, create a present list based on the image analysis result, wherein the present list comprises a plurality of present regions, and each present region correspondingly presents relevant information of a target view control; and
present the relevant information of the target view control in the corresponding present region of the present list, wherein the relevant information comprises at least one of the following: the control image, the image information, or the image analysis result.

In a possible implementation, in a case that the relevant information comprises the image analysis result, the apparatus is further configured to:
in a case that it is determined, based on the image analysis result, that the control image comprises an abnormal control image, determine abnormal label information of the abnormal control image; and
present the abnormal control image in the corresponding present region of the present list according to the abnormal label information.

In a possible implementation, the second obtaining unit 54 is further configured to:
obtain a current image size of the control image and an original image size of the control image from the image information;
compare the current image size with the original image size to obtain a comparison result; and
in a case that it is determined, based on the comparison result, that the original image size is greater than the current image size, determine the control image as an abnormal control image.

In a possible implementation, the image information comprises at least one of the following: a current image size of the control image, a memory usage of the control image in the terminal device, an original image size of the control image, or an image source of the control image.

In a possible implementation, the second obtaining unit 54 is further configured to:
obtain control image data returned by the terminal device based on the image obtaining request; and
perform format transformation on the control image data according to a preset data format to obtain the control image and image information of the target view control, wherein the preset data format is a data format matched with the Flutter performance debugger.

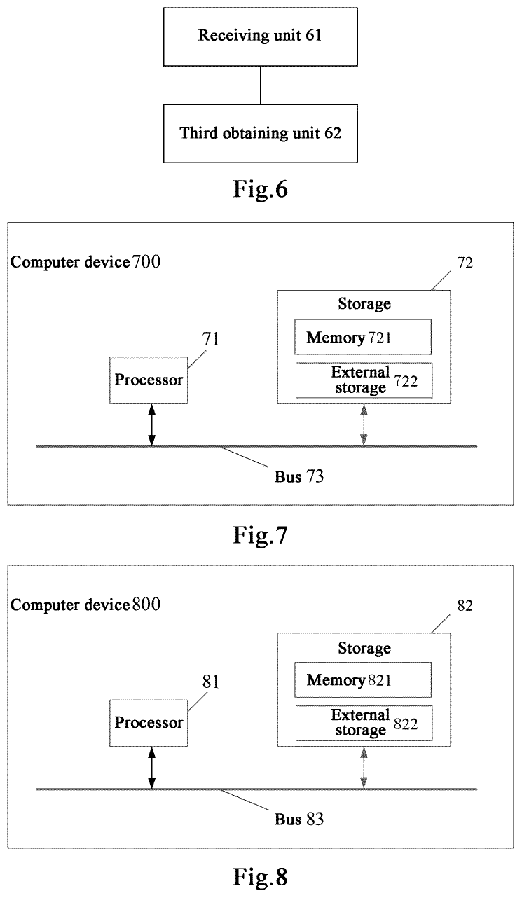

FIG. 6 shows a schematic diagram of another image analysis apparatus provided by embodiments of the present disclosure, which is configured in a terminal device running a target application. The apparatus comprises: a receiving unit 61 and a third obtaining unit 62.

The receiving unit 61 is configured to: receive an image obtaining request sent by a Flutter performance debugger, and determine a target view control corresponding to the image obtaining request; and

the third obtaining unit 62 is configured to: obtain a control image and image information of the target view control, and return the control image and the image information to the Flutter performance debugger.

In the embodiments of the present disclosure, a target view control, containing an image, in a target application can be determined; and image information of the control image in the target view control is obtained and is analyzed to obtain an analysis result of the control image. As such, a developer can determine an unreasonable control image according to the analysis result and adjusts the control image, so as to reduce the impact of image loading on the display performance of the terminal device and reduce a memory load on the target application during use.

In a possible implementation, the receiving unit 61 is further configured to:
determine view control information contained in the image obtaining request; and
determine a view control corresponding to the view control information as the target view control.

In a possible implementation, the third obtaining unit 62 is further configured to:
determine view control information contained in the image obtaining request; and
obtain control attribute information of the target view control;
perform a loading operation for the control image of the target view control in the control attribute information based on a loading parameter to obtain a loading result, and determine a current image size of the control image based on the loading result, wherein the loading result is used for indicating a rendering result of the control image, and the loading parameter comprises at least one of the following: an original image size of the control image, a memory usage of the control image in the terminal device, or an image source of the control image; and
determine the control image and the image information of the target view control according to the loading result and the loading parameter.

In a possible implementation, the third obtaining unit 62 is further configured to:
determine a preset data format matched with the Flutter performance debugger;
perform data format transformation on the control image and the image information of the target view control according to the preset data format to obtain control image data of the target view control; and
transmit, through a debug extension application of the Flutter application, the control image data of the target view control into the Flutter performance debugger for processing.

The descriptions of the processing flows of the various units in the apparatus and the descriptions of the interaction flows between the various units can be found in the relevant explanations in the above method embodiments, and will not be elaborated here.

Corresponding to the image analysis method in FIG. 1, the embodiments of the present disclosure further provide a computer device 700. FIG. 7 shows a schematic structural diagram of a computer device 700 provided by embodiments of the present disclosure, comprising:
a processor 71, a storage 72, and a bus 73. The storage 72 is configured to store execution instructions, and comprises a memory 721 and an external storage 722. The memory 721, also referred to as an internal storage, is configured to temporarily store operational data in the processor 71 and data exchanged with the external storage 722 such as a hard disk drive. The processor 71 exchanges data with the external storage 722 through the memory 721. When the computer device 700 runs, the processor 71 communicates with the storage 72 through the bus 73, causing the processor 71 to execute the following instructions:
in response to an image analysis instruction for a target page in a target application, obtaining control attribute information of various view controls of the target page;
determining a target view control from the various view controls based on the control attribute information, wherein the target view control is an image control containing an image;
generating an image obtaining request based on the target view control, and sending the image obtaining request to a terminal device, wherein the image obtaining request is used for instructing the terminal device to obtain a control image and image information of the target view control; and
obtaining the control image and the image information contained in the target view control which are returned by the terminal device based on the image obtaining request, and performing, based on the image information, image analysis on the control image to obtain an image analysis result.

Corresponding to the image analysis method in FIG. 4, the embodiments of the present disclosure further provide another computer device 800. FIG. 8 shows a schematic structural diagram of a computer device 800 provided by embodiments of the present disclosure, comprising:
a processor 81, a storage 82, and a bus 83. The storage 82 is configured to store execution instructions, and comprises a memory 821 and an external storage 822. The memory 821, also referred to as an internal storage, is configured to temporarily store operational data in the processor 81 and data exchanged with the external storage 822 such as a hard disk drive. The processor 81 exchanges data with the external storage 822 through the memory 821. When the computer device 800 runs, the processor 81 communicates with the storage 82 through the bus 83, causing the processor 81 to execute the following instructions:
receiving an image obtaining request sent by a Flutter performance debugger, and
determining a target view control corresponding to the image obtaining request; and
obtaining a control image and image information of the target view control, and returning the control image and the image information to the Flutter performance debugger.

The embodiments of the present disclosure further provide a computer-readable storage medium, having a computer program stored thereon. The computer program, when run by a processor, execute the steps of the image analysis method in the above method embodiments. The storage medium may be a volatile or a non-volatile computer-readable storage medium.

The embodiments of the present disclosure further provide a computer program product. The computer product carries program codes, and instructions comprised in the program codes can be used for executing the steps of the image analysis method in the above method embodiments. Specific details can be found in the method embodiments described above, and will not be elaborated here.

The aforementioned computer program product can be specifically implemented through hardware, software, or a combination of hardware and software. In an optional embodiment, the computer program product is specifically embodied as a computer storage medium, while in another optional embodiment, the computer program product is specifically embodied as a software product, such as a Software Development Kit (SDK).

A person skilled in the art can clearly understand that for the convenience and conciseness of the description, specific working processes of the system and apparatus described above can be found in the corresponding processes in the aforementioned method embodiments, and will not be described in detail here. In the several embodiments provided by the present disclosure, it should be understood that the disclosed system, apparatus, and method are achieved in other manners. The above-described apparatus embodiments are merely illustrative. For example, the division of the units is only one type of logical functional division, and other divisions is achieved in practice. For another example, multiple units or components can be combined or integrated into another system, or some features can be omitted, or not executed. In addition, the shown or discussed mutual coupling or direct coupling or communication connection is an indirect coupling or communication connection through some communication interfaces, apparatuses or units, and is in an electrical, mechanical or another form.

The units described as separate parts may or may not be physically separate, and parts displayed as units may or may not be physical units, may be located in one position, or may be distributed on a plurality of network units. Some or all of the units are selected according to actual needs to achieve the objective of the solution of this embodiment.

In addition, the functional units in various embodiments of the present disclosure may be integrated in a single processing unit. The units may exist physically separately, or two or more units may be integrated in one unit.

When the functions are implemented in the form of software functional units and sold or used as independent products, the functions may be stored in a non-volatile computer-readable storage medium executable by a processor. Based on such an understanding, the technical solutions of the present disclosure essentially, or the part contributing to the prior art, or some of the technical solutions may be presented in the form of a software product. The computer software product is stored in a storage medium, and comprises several instructions for instructing a computer device (which may be a personal computer, a server, a network device, or the like) to perform all or some of the steps of the methods of the various embodiments of the present disclosure. The aforementioned storage media comprise: various media that can store program codes, such as a USB flash drive, a mobile hard disk drive, a Read-Only Memory (ROM), a Random Access Memory (RAM), a magnetic disk, and a compact disc.

It should be finally noted that the above embodiments are only specific embodiments of the present disclosure and are intended to explain the technical solutions of the present disclosure, rather than limiting them. The protection scope of the present disclosure is not limited to this. Although detailed explanations have been made to the present disclosure by referring to the aforementioned embodiments, a person of ordinary skill in the art should understand that any person skilled in the art can still modify the technical solutions recorded in the aforementioned embodiments or easily think of changes within the scope disclosed by the present disclosure, or equivalently replace some of the technical features. These modifications, changes, or replacements do not separate the essences of the corresponding technical solutions from the spirit and scope of the embodiments of the present disclosure, and should fall within the protection scope of the present disclosure. Therefore, the protection scope of the present disclosure shall be subject to the claims.

1. An image analysis method, comprising:
in response to an image analysis instruction for a target page in a target application, obtaining control attribute information of various view controls of the target page;
determining a target view control from the various view controls based on the control attribute information, wherein the target view control is an image control containing an image;
generating an image obtaining request based on the target view control, and sending the image obtaining request to a terminal device, wherein the image obtaining request is used for instructing the terminal device to obtain a control image and image information of the target view control; and
obtaining the control image and the image information contained in the target view control which are returned by the terminal device based on the image obtaining request, and performing, based on the image information, image analysis on the control image to obtain an image analysis result.

2. The method according to claim 1, wherein determining the target view control from the various view controls based on the control attribute information comprises:
obtaining a control structure tree of a plurality of the view controls, and determining a main view control corresponding to a root node of the control structure tree, wherein the control structure tree comprises a plurality of nodes and hierarchical relationships between individual ones of the plurality of nodes, and each node corresponds to a view control in the target page; and
traversing the control structure tree based on the main view control to obtain the target view control.

3. The method according to claim 2, wherein traversing the control structure tree based on the main view control to obtain the target view control comprises:
traversing, by using the main view control as a start view control, the control attribute information of the various view controls in the control structure tree to obtain an attribute traversing result; and
determining a view control comprising an image attribute in the attribute traversing result as the target view control.

4. The method according to claim 1, wherein the method further comprises:
after performing, based on the image information, the image analysis on the control image to obtain the image analysis result, creating a present list based on the image analysis result, wherein the present list comprises a plurality of present regions, and each present region correspondingly presents relevant information of a target view control; and
presenting the relevant information of the target view control in the corresponding present region of the present list, wherein the relevant information comprises at least one of the following: the control image, the image information, or the image analysis result.

5. The method according to claim 4, wherein the relevant information comprises the image analysis result, and presenting the relevant information of the target view control in the corresponding present region of the present list comprises:
in a case that it is determined, based on the image analysis result, that the control image comprises an abnormal control image, determining abnormal label information of the abnormal control image; and
presenting the abnormal control image in the corresponding present region of the present list according to the abnormal label information.

6. The method according to claim 1, wherein performing, based on the image information, the image analysis on the control image to obtain the image analysis result comprises:
obtaining, from the image information, a current image size of the control image and an original image size of the control image;
comparing the current image size with the original image size to obtain a comparison result; and
in a case that it is determined, based on the comparison result, that the original image size is greater than the current image size, determining the control image as an abnormal control image.

7. The method according to claim 1, wherein the image information comprises at least one of the following: a current image size of the control image, a memory usage of the control image in the terminal device, an original image size of the control image, or an image source of the control image.

8. The method according to claim 1, wherein obtaining the control image and the image information contained in the target view control which are returned by the terminal device based on the image obtaining request comprises:
obtaining control image data returned by the terminal device based on the image obtaining request; and
performing format transformation on the control image data according to a preset data format to obtain the control image and the image information of the target view control, wherein the preset data format is a data format matched with a Flutter performance debugger.

9. An image analysis method, wherein the method is applied to a terminal device running a target application and comprises:
receiving an image obtaining request sent by a Flutter performance debugger, and determining a target view control corresponding to the image obtaining request; and
obtaining a control image and image information of the target view control, and returning the control image and the image information to the Flutter performance debugger.

10. The method according to claim 9, wherein determining the target view control corresponding to the image obtaining request comprises:
determining view control information contained in the image obtaining request; and
determining a view control corresponding to the view control information as the target view control.

11. The method according to claim 9, wherein obtaining the control image and the image information of the target view control comprises:
obtaining control attribute information of the target view control;
performing a loading operation for the control image of the target view control in the control attribute information based on a loading parameter to obtain a loading result, and determining a current image size of the control image based on the loading result, wherein the loading result is used for indicating a rendering result of the control image, and the loading parameter comprises at least one of the following: an original image size of the control image, a memory usage of the control image, or an image source of the control image; and
determining the control image and image information of the target view control according to the loading result and the loading parameter.

12. The method according to claim 9, wherein the method further comprises, after obtaining the control image and the image information of the target view control:
determining a preset data format matched with the Flutter performance debugger;
performing data format transformation on the control image and the image information of the target view control according to the preset data format to obtain control image data of the target view control; and
transmitting, through a debug extension application of the Flutter application, the control image data of the target view control into the Flutter performance debugger for processing.

13-14. (canceled)

15. A computer device, wherein the computer device comprises a processor, a storage, and a bus, wherein the storage stores machine-readable instructions executable by the processor; when the computer device runs, the processor communicates with the storage through the bus; and the machine-readable instructions, when executed by the processor, cause the processor to:
in response to an image analysis instruction for a target page in a target application, obtain control attribute information of various view controls of the target page;
determine a target view control from the various view controls based on the control attribute information, wherein the target view control is an image control containing an image;
generate an image obtaining request based on the target view control, and send the image obtaining request to a terminal device, wherein the image obtaining request is used for instructing the terminal device to obtain a control image and image information of the target view control; and
obtain the control image and the image information contained in the target view control which are returned by the terminal device based on the image obtaining request, and perform, based on the image information, image analysis on the control image to obtain an image analysis result.

16-17. (canceled)

18. The computer device according to claim 15, wherein the computer device being caused to determine the target view control from the various view controls based on the control attribute information comprises being caused to:
obtain a control structure tree of a plurality of the view controls, and determine a main view control corresponding to a root node of the control structure tree, wherein the control structure tree comprises a plurality of nodes and hierarchical relationships between individual ones of the plurality of nodes, and each node corresponds to a view control in the target page; and
traverse the control structure tree based on the main view control to obtain the target view control.

19. The computer device according to claim 18, wherein the computer device being caused to traverse the control structure tree based on the main view control to obtain the target view control comprises being caused to:
traverse, by using the main view control as a start view control, the control attribute information of the various view controls in the control structure tree to obtain an attribute traversing result; and
determine a view control comprising an image attribute in the attribute traversing result as the target view control.

20. The computer device according to claim 15, wherein the computer device is further caused to:
after performing, based on the image information, the image analysis on the control image to obtain the image analysis result, create a present list based on the image analysis result, wherein the present list comprises a plurality of present regions, and each present region correspondingly presents relevant information of a target view control; and
present the relevant information of the target view control in the corresponding present region of the present list, wherein the relevant information comprises at least one of the following: the control image, the image information, or the image analysis result.

21. The computer device according to claim 20, wherein the relevant information comprises the image analysis result, and the computer device being caused to present the relevant information of the target view control in the corresponding present region of the present list comprises being caused to:
in a case that it is determined, based on the image analysis result, that the control image comprises an abnormal control image, determine abnormal label information of the abnormal control image; and
present the abnormal control image in the corresponding present region of the present list according to the abnormal label information.

22. The computer device according to claim 15, wherein the computer device being caused to perform, based on the image information, the image analysis on the control image to obtain the image analysis result comprises being caused to:
obtain, from the image information, a current image size of the control image and an original image size of the control image;
compare the current image size with the original image size to obtain a comparison result; and
in a case that it is determined, based on the comparison result, that the original image size is greater than the current image size, determine the control image as an abnormal control image.

23. The computer device according to claim 15, wherein the image information comprises at least one of the following: a current image size of the control image, a memory usage of the control image in the terminal device, an original image size of the control image, or an image source of the control image.

24. The computer device according to claim 15, wherein the computer device being caused to obtain the control image and the image information contained in the target view control which are returned by the terminal device based on the image obtaining request comprises being caused to:
obtain control image data returned by the terminal device based on the image obtaining request; and
perform format transformation on the control image data according to a preset data format to obtain the control image and the image information of the target view control, wherein the preset data format is a data format matched with a Flutter performance debugger.
